(19) United States
(12) Patent Application Publication
(10) Pub. No.: US 2007/0138885 A1
(43) Pub. Date: Jun. 21, 2007

(54) Windshield wiper device

(75) Inventors: Claus Fleischer, Buehl (DE); Achim Hawighorst, Buehlertal (DE)

Correspondence Address: MICHAEL BEST & FRIEDRICH, LLP, 100 E WISCONSIN AVENUE, Suite 3300, MILWAUKEE, WI, 53202, US

(73) Assignee: ROBERT BOSCH GMBH, Stuttgart (DE)

(21) Appl. No.: 11/606,350

(22) Filed: Nov. 29, 2006

(30) Foreign Application Priority Data
Dec. 20, 2005 (DE) 102005060863.9

(51) Int. Cl. H02K 7/10; H02P 15/00; H02K 7/06

(52) U.S. Cl. 310/77; 310/93; 310/83; 310/75 R

(57) ABSTRACT

A windshield wiper device for vehicles. The invention provides that the armature shaft (5) of the electromotive drive (2) be positioned so that it is not displaceable, and that the adjusting device (20) include an armature plate (21) for transferring the blocking element (16) from its blocked position to its released position, which armature plate is adjustable via the magnetic adjusting force of the energized electromotive drive (2).

### BACKGROUND OF THE INVENTION

The invention relates to a windshield wiper device. A windshield wiper device for motor vehicles is known from DE 102 59 154 A1, which has an electrically reversible device with an armature shaft. The armature shaft supports an output worm, which meshes with a worm wheel, which in turn drives an output shaft. In the case of the known windshield wiper device, a blocking element embodied as a swiveling lever is provided with a locking nose, with which the worm wheel can be mechanically blocked from rotation when the armature shaft is stationary. The blocking element can be adjusted with an adjusting device between its blocked position and a released position. The adjusting device is formed by an armature shaft that is positioned so that it is linearly displaceable, and the armature shaft is coupled with the blocking element that is embodied as a swiveling lever. If the armature of the drive is energized, the armature shaft is not just put into rotation, but it also executes an axial movement because of the magnetic flux, and this movement is used to transfer the blocking element to the released position. The disadvantage of the known windshield wiper device is the expensive axially displaceable bearing of the armature shaft. Moreover, it is disadvantageous that a transfer of the blocking element from its blocked position to its released position always produces undesirable torsion of the worm wheel because of the coupling of the axially displaceable armature shaft with the worm wheel. The document further discloses the use of a separate electric motor, piezoelectric element or electric lifting magnet with a lift rod for adjusting the blocking element. The disadvantage of all these alternative solutions is that an additional drive has to be provided for adjusting the blocking element, a fact that negatively impacts manufacturing costs.

A drive for a windshield wiper device is known from DE 101 25 836 A1 in which the armature shaft is rotationally secured exclusively on the basis of the magnetic field of permanent magnets. The disadvantage of this is the lack of a mechanic blocking that prevents a movement of the wiper blades even with the effects of extreme force.

### SUMMARY OF THE INVENTION

The invention is based on the objective of proposing a windshield wiper device with a mechanical blocking element, in which the actuation of the adjusting device for adjusting the blocking element from its blocked position to its released position does not produce any torsion of the worm wheel and therefore of the wiper arms.

The invention is based on the idea of dispensing with an axial displaceability of the armature shaft and positioning it so that it cannot be displaced axially. According to the invention, it is further provided that the actuation of the adjusting device is accomplished independent of an adjustment of the armature shaft, however while utilizing the magnetic field of the armature package with armature winding. For this purpose, the adjusting device includes an armature plate, which is coupled with the blocking element in such a way that a movement of the armature plate causes an adjustment of the blocking element. The at least partially ferromagnetic armature plate begins to interact with the magnetic field of the armature package. If the armatures are energized, then because of the magnetic field that originates, a magnetic adjusting force acts on the armature plate so that it moves. Because of the coupling of the armature plate with the blocking plate, the movement of the armature plate is transmitted to the blocking element so that said blocking element is transferred from its blocked position to its released position and releases the worm wheel and/or the drive shaft and/or the armature shaft for wiper operation. Because of utilizing the magnetic field of the electromotive drive, it is possible to advantageously dispense with a separate drive for actuating the adjusting device.

The adjusting device advantageously comprises a spring element, which counteracts the adjustment of the blocking element into its released position. The spring element is used to restore the blocking element to its blocked position when the drive is not energized. It must be guaranteed that the spring force does not exceed the magnetic adjusting force acting on the armature plate.

An embodiment of the invention provides for the armature plate to be guided so that it is linearly moveable. In this case, e.g., at least two guide rods that penetrate the armature plate can be provided, which force a guided straight-line movement of the armature plate.

It is expedient if the armature plate is penetrated by the armature shaft and can be adjusted in the axial direction along the armature shaft. In this case, the armature plate is advantageously embodied to be symmetrical to the armature shaft in order to avoid a wedging up of the armature plate during its linear movement. According to this preferred embodiment, the armature plate is arranged coaxially to the armature shaft and parallel to the radial plane of the armature package.

It is advantageous if the blocking element is embodied as a rocker lever, which is positioned so that it can swivel around a swivel joint. Due to the embodiment of the blocking element as a rocker lever, it is possible to realize great blocking forces in a simple way.

The coupling of the armature plate with the rocker lever is preferably accomplished via a tension/pressure rod. Said tension/pressure rod is advantageously connected in an articulated manner to an extension arm of the rocker lever. The tension/pressure rod transmits the magnetic adjusting forces acting on the armature plate directly to the rocker lever. It is also conceivable to dispense with a rocker lever and embody the tension/pressure rod as a blocking element, which directly blocks a rotatable part of the windshield wiper device mechanically, particularly by form closure or non-positively.

According to a first variation of the embodiment of the windshield wiper device, the spring element is arranged in an area between the armature plate and the armature package. In this connection, the spring element is supported on one end on the armature plate and on another end on a component that cannot be displaced linearly. A discoid, radial projection for supporting the spring element is provided on the armature shaft for example.

According to another alternative embodiment of the invention, the spring element is localized between an extension arm of the blocking element that is embodied as a rocker lever and a non-displaceable component. In particular, the spring element is supported on a housing wall. A helical spring is preferably used as the spring element.

In order to guarantee optimal mechanical blocking of the rotatable components of the windshield wiper device, it is viewed as advantageous that the blocking element has a locking nose, which, in the blocked position, engages in a recess of the worm wheel and/or the output shaft and/or the armature shaft. Of course, the blocking element can also feature a recess, which accommodates a locking nose of a rotatable component. The recess or the locking nose is advantageously arranged in such a way that a wiper arm being driven by the drive shaft is situated in its parked position when the locking nose engages in the recess.

### BRIEF DESCRIPTION OF THE DRAWINGS

Additional advantages and expedient embodiments can be found in the additional claims, the description of the figures and the drawings. The drawings show:

FIG. 1 A first exemplary embodiment of a windshield wiper device having a linearly displaceable armature plate as well as a spring element arranged between the armature plate and the armature package

FIG. 2 Another exemplary embodiment of a windshield wiper device in which the spring element is arranged between blocking element embodied as a rocker lever and a housing wall

FIG. 3 A side view of a schematic representation of a worm wheel according to FIG. 1

The same components and components having the same function are identified in the figures with the same reference numbers.

### DETAILED DESCRIPTION

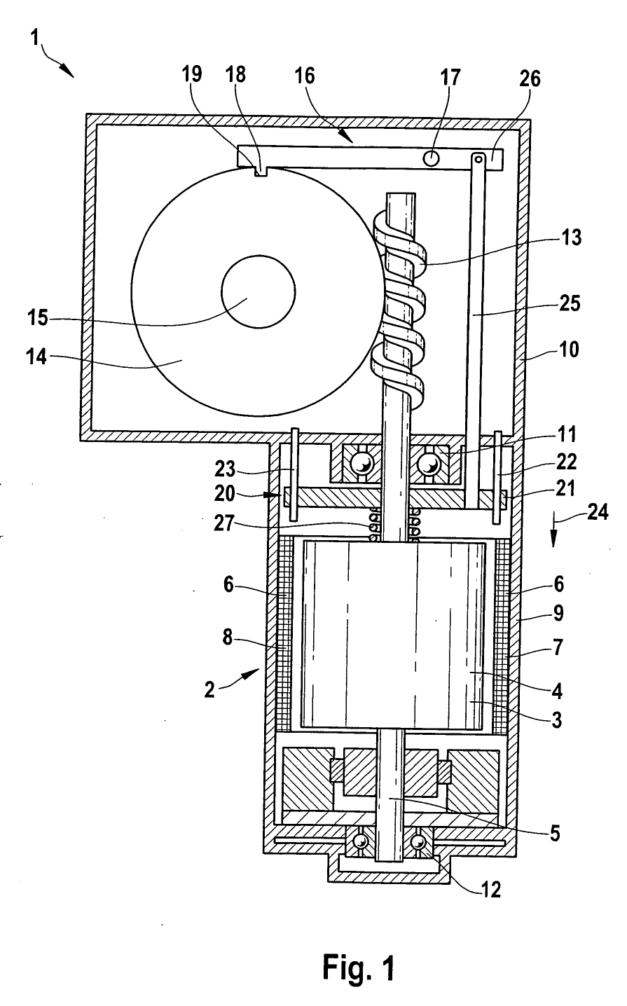

FIG. 1 shows a schematic representation of a windshield wiper device 1 in accordance with the invention. The windshield wiper device 1 has a reversible electromotive drive 2. The electromotive drive 2 has a rotor 3, which is embodied as an armature package 4 with armature windings. The armature package 4 is arranged in a rotationally secured manner on an armature shaft 5, which is put into rotation when the armature package 4 is energized together with the armature package. The armature package 4 is arranged rotatably within a stator 6, which is formed by two permanent magnets 7, 8 having different poles. The electromotive drive 2 comprised of the armature package 4 and the permanent magnets 7, 8, is arranged in a motor housing 9.

The armature shaft 5 is guided out of the motor housing 9 and projects into a gear housing 10. The armature shaft 5 is positioned by means of two spaced-apart bearings 11, 12 so that it can rotate but is not axially displaceable. The armature shaft 5 that is embodied as an output worm 13 in the area of its free end meshes with a worm wheel 14 within the gear housing 10. The rotational axes of the worm wheel 14 and the armature shaft 5 or the output worm 13 are arranged at a right angle to one another. An output shaft 15 is connected in a rotationally secured manner to the worm wheel 14.

As a rule, the output shaft 15 is connect to a crank (not shown), which drives, via a thrust rod, wiper shafts to which wiper arms with wiper blades are fastened. Driving a wiper arm directly by means of an output shaft 15 is also conceivable.

A blocking element 16 embodied as a rocker lever is provided for realizing a self-locking of the windshield wiper device 1. The blocking element 16 is positioned so that it can swivel around a swivel joint 17. The blocking element 16 is provided with a locking nose 18, which, in the depicted blocked position of the blocking element 16, engages radially in a recess 19 of the worm wheel 14. As a result, the worm wheel 14 is blocked when the armature package 4 is not energized, whereby the wiper arms that are connected directly or indirectly to the output shaft 15 are parked so that they are not movable. In order to transfer the blocking element 16 from the depicted blocked position to a released position in which the locking nose 18 is no longer engaged in the recess 19, the blocking element 16 must swivel around the swivel joint 17. To do so, an adjusting device 20 is provided, which features a linearly guided armature plate 21 made of a ferromagnetic material, e.g., steel plate. The armature plate 21 is arranged coaxially to the armature shaft 5 and is penetrated by said armature shaft. Moreover, the armature plate 21 is embodied symmetrically to the armature shaft 5. The linearly displaceable bearing of the armature plate is realized via two spaced-apart bearing rods 22, 23, which are aligned parallel to the armature shaft 5 and held by the gear housing 10. Because of this bearing, the armature plate 21 can be displaced linearly along the armature shaft 5.

If the windings of the armature package 4 are energized, a magnetic field with a magnetic flux originates. An adjusting force acting on the armature plate 21 is generated by the magnetic field, whereby the armature plate 21 is moved along the guide rods 22, 23 in the arrow direction 24 in the direction of the armature package 4. The armature plate 21 is tightly connected with a tension/pressure rod 25, which is coupled in turn in an articulated manner with an extension arm 26 of the blocking element 16. Because of the movement of the armature plate 21 in arrow direction 24 when the armature package is energized, the blocking element is consequently swiveled around the swivel joint 17 in such a way that the locking nose 18 swivels out of the recess 19 of the worm wheel 14. The blocking element 16 is kept in the thereby achieved released position via the magnetic adjusting force acting on the armature plate 21 as long as the armature package 4 is energized.

So that the blocking element 16 returns to its blocked position as shown in FIG. 1 when the electromotive drive 2 is turned off, a spring element 27, e.g., a helical spring, is arranged between the armature package 4 and the ferromagnetic armature plate 21. It is pre-tensioned when displacing the armature plate 21 in armature plate 21 in arrow direction 24. As soon as the electromotive drive 2 is not longer energized, the spring element 27 presses the armature plate 21 away from the armature package 4 against arrow direction 24, thereby swiveling the blocking element 16 back into its blocked position. The spring element 27 is supported, on the one hand, on the armature plate 21 and, on the other hand, on a non-displaceable component (not shown) that is arranged between the armature package 4 and the spring element 27. Said component can be held, e.g., on the armature shaft 5.

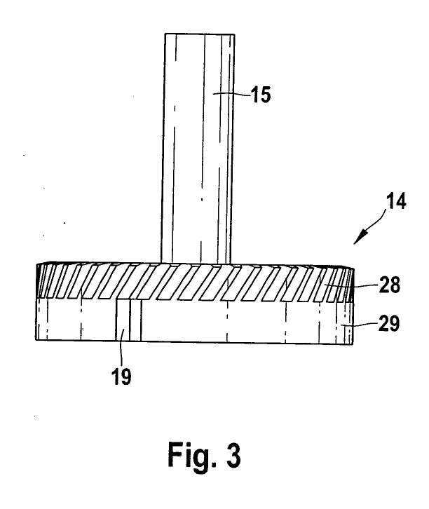

FIG. 3 shows a side view of the worm wheel 14 with the output shaft 15 fastened to it. It shows that the worm wheel 14 is structured in two parts in the axial direction. A first section 28 has a worm contour, which meshes with the output worm 13. The second section 29 features the recess 19 into which the locking nose 18 of the blocking element 16 engages in the blocked position.

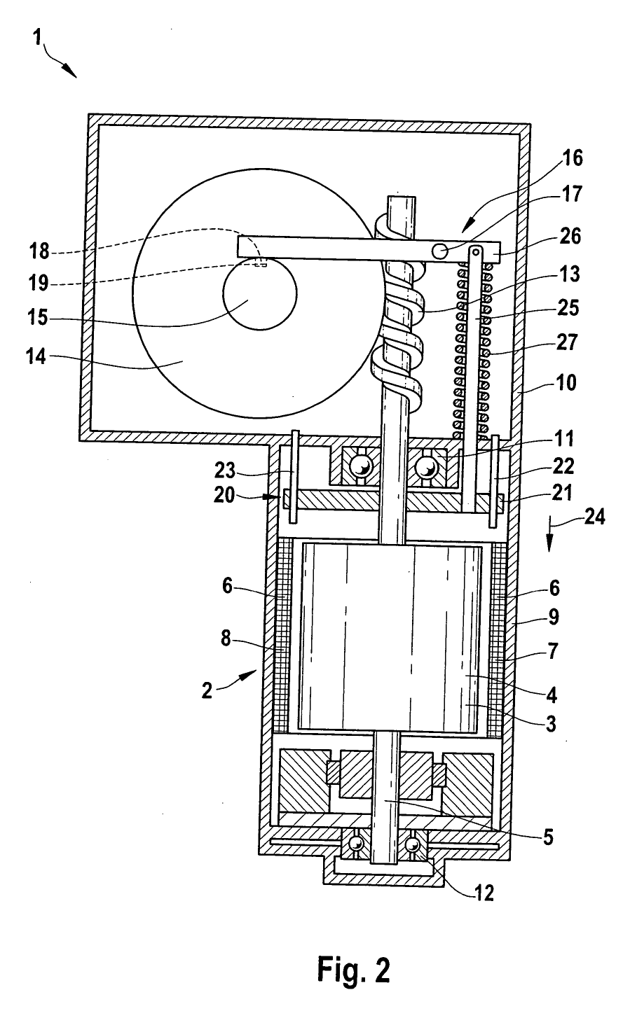

FIG. 2 depicts an alternatively embodied windshield wiper device 1. The following will make reference only to the differences from the windshield wiper device 1 depicted in FIG. 1. Reference is made to the foregoing description of the figures with regard to the commonalities.

In contrast to the windshield wiper device according to FIG. 1, the blocking element 16 with the locking nose 18 does not directly block the worm wheel 14, but the drive shaft 15. To do so, a recess 19 is introduced in the circumference of the drive shaft 15 into which the locking nose 18 of the blocking element 16 that is embodied as a rocker lever can engage. It is also conceivable as an alternative for the blocking element 16 to be arranged such that it directly blocks the armature shaft 5. In addition to producing a form closure, as in the case at hand, blocking by means of a non-positive, particularly frictional, connection is also conceivable.

Another difference from the windshield wiper device 1 shown in FIG. 1 consists of the arrangement of the spring element 27. Said spring element is supported, on the one hand, on the extension arm 26 of the blocking element 16 and, on the other hand, on the inner wall of the gear housing 10. The restoring effect that is hereby produced is, however, the same as in the embodiment according to FIG. 1. When the electromotive drive 2 is not energized, the blocking element 16 is swiveled back around the swivel joint 17 into its blocked position via the spring element 27.

1. Windshield wiper device, with at least one electric drive (2) having an armature shaft (5), and with an armature package (4) arranged on the armature shaft (5), wherein the armature shaft (5) is embodied at least in sections as an output worm (13), which meshes with a worm wheel (14), which drives an output shaft (15), wherein a blocking element (16) is provided, which can be adjusted via an adjusting device (20) between a blocked position, in which it mechanically blocks the worm wheel (14) and/or the output shaft (15) and/or the armature shaft (5) from rotating, and a released position, wherein the adjusting device (20) can be actuated by means of a magnetic adjusting force resulting from the magnetic field of the energized armature package (4), characterized in that the armature shaft (15) is positioned so that it is not axially displaceable, and that the adjusting device (20) has an at least partially ferromagnetic armature plate (21) that is coupled with the blocking element (16) and is adjustable via the magnetic adjusting force of the energized armature package (4).

2. Windshield wiper device according to claim 1, characterized in that the transfer of the blocking element (16) from its blocked position to its released position is accomplished against the force of a spring element (27).

3. Windshield wiper device according to claim 1, characterized in that the armature plate (21) is guided so that it is linearly moveable.

4. Windshield wiper device according to claim 1, characterized in that the armature plate (21) is penetrated by the armature shaft (5) and can be adjusted in the axial direction along the armature shaft (5).

5. Windshield wiper device according to claim 1, characterized in that the blocking element (16) is embodied as a rocker lever positioned so that it can swivel around a swivel joint (17).

6. Windshield wiper device according to claim 5, characterized in that the armature plate (21) is coupled via a rod (25) that is connected preferably in an articulated manner to the rocker lever.

7. Windshield wiper device according to claim 2, characterized in that the spring element (27) is arranged between the armature plate (21) and the armature package (4) and is supported on the armature plate (21).

8. Windshield wiper device according to claim 6, characterized in that the spring element (27) is supported, on the one hand, on the rocker lever and, on the other hand, on a non-displaceable component, a housing wall.

9. Windshield wiper device according to claim 1, characterized in that the blocking element (16) has a locking nose (18), which, in the blocked position, engages in a recess (19) of the worm wheel (14) and/or the output shaft (15) and/or the armature shaft (5), and that the recess (19) is arranged in such a way that a wiper arm being driven by the output shaft (5) is situated in its parked position when the locking nose (18) engages in the recess (19).

10. Windshield wiper device according to claim 2, characterized in that the armature plate (21) is guided so that it is linearly moveable.

11. Windshield wiper device according to claim 10, characterized in that the armature plate (21) is penetrated by the armature shaft (5) and can be adjusted in the axial direction along the armature shaft (5).

12. Windshield wiper device according to claim 11, characterized in that the blocking element (16) is embodied as a rocker lever positioned so that it can swivel around a swivel joint (17).

13. Windshield wiper device according to claim 12, characterized in that the armature plate (21) is coupled via a rod (25) that is connected preferably in an articulated manner to the rocker lever.

14. Windshield wiper device according to claim 13, characterized in that the spring element (27) is arranged between the armature plate (21) and the armature package (4) and is supported on the armature plate (21).

15. Windshield wiper device according to claim 14, characterized in that the spring element (27) is supported, on the one hand, on the rocker lever and, on the other hand, on a non-displaceable component, a housing wall.

16. Windshield wiper device according to claim 15, characterized in that the blocking element (16) has a locking nose (18), which, in the blocked position, engages in a recess (19) of the worm wheel (14) and/or the output shaft (15) and/or the armature shaft (5), and that the recess (19) is arranged in such a way that a wiper arm being driven by the output shaft (5) is situated in its parked position when the locking nose (18) engages in the recess (19).
